(19) United States
(12) Patent Application Publication
(10) Pub. No.: US 2016/0285090 A1
(43) Pub. Date: Sep. 29, 2016

(54) SILICON OXIDE NANOTUBE ELECTRODE AND METHOD

(71) Applicant: THE REGENT OF THE UNIVERSITY OF CALIFORNIA, Oakland, CA (US)

(72) Inventors: Cengiz S Ozkan, San Diego, CA (US); Mihrimah Ozkan, San Diego, CA (US); Zachary Favors, Corona, CA (US); Wei Wang, Newport Beach, CA (US)

(21) Appl. No.: 15/034,052

(22) PCT Filed: Nov. 14, 2014
(86) PCT No.: PCT/US14/65717

§ 371 Date: May 3, 2016

Related U.S. Application Data
(60) Provisional application No. 61/904,966, filed on Nov. 15, 2013.

(51) Int. Cl. H01M 4/48; H01M 4/139; H01M 4/13; H01M 10/0525

(52) U.S. Cl. CPC H01M 4/483; H01M 10/0525; H01M 4/139; H01M 4/13; H01M 2004/027

(57) ABSTRACT

A silicon oxide nanotube electrode and methods are shown, that are fabricated via single step hard-template growth method and evaluated as an anode for Li-ion batteries. SiOx nanotubes exhibit a highly stable reversible capacity with no capacity fading. Devices such as lithium ion batteries are shown incorporating silicon oxide nanotube electrodes.

### RELATED APPLICATION

This application claims priority to U.S. Provisional Patent Application No. 61/904,966, entitled “SILICON OXIDE NANOTUBE ELECTRODE AND METHOD,” filed on Nov. 15, 2013, which is incorporated herein by reference in its entirety.

### TECHNICAL FIELD

This invention relates to electrode materials and methods.

### BACKGROUND

Improved batteries, such as lithium ion batteries are desired. One example of a battery structure that can be improved is an anode structure.

### BRIEF DESCRIPTION OF THE DRAWINGS

FIG. 1 shows stages of fabrication of silicon oxide nanotubes according to an example of the invention.

FIG. 2A shows a scanning electron microscope (SEM) image of silicon oxide nanotubes with a scale bar of 1 μm according to an example of the invention.

FIG. 2B shows an SEM image of silicon oxide nanotubes with a scale bar of 2 μm according to an example of the invention.

FIG. 2C shows an SEM image of silicon oxide nanotubes with a scale bar of 25 μm according to an example of the invention.

FIG. 2D shows an SEM image of silicon oxide nanotubes with a scale bar of 20 μm according to an example of the invention.

FIG. 3A shows a transmission electron microscope (TEM) image of a silicon oxide nanotube with a scale bar of 50 nm according to an example of the invention.

FIG. 3B shows another transmission electron microscope (TEM) image of silicon oxide nanotubes with a scale bar of 50 nm according to an example of the invention.

FIG. 4A shows charge-discharge capacity versus cycle number data of an electrode according to an example of the invention.

FIG. 4B shows cyclic voltammetry data of an electrode according to an example of the invention.

FIG. 4C shows galvanostatic voltage profile data of an electrode according to an example of the invention.

FIG. 4D shows galvanostatic voltage profile data of an electrode at selected C rages according to an example of the invention.

FIG. 5 shows a battery according to an example of the invention.

FIG. 6 shows a method of forming a material according to an example of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

SiOₓ nanotubes are shown, that are fabricated via single step hard-template growth method and evaluated as an anode for Li-ion batteries. SiOₓ nanotubes exhibit a highly stable reversible capacity of 1447 mAhg-1 after 100 cycles with no capacity fading. The hollow nature of the SiOₓ nanotubes (NTs) accommodates the large volume expansion experienced by Si-based anodes during lithiation and delithiation. The thin walls of the SiOₓ NTs allow for effective reduction in Li-ion diffusion path distance and, thus, affords a good rate cyclability. The high aspect ratio character of these nanotubes allow for a scalable fabrication method of nanoscale SiOₓ-based anodes.

Silicon as an anode material shows a high theoretical capacity of 4200 mAhg-1 and is relatively abundant. However, Si undergoes volume expansion upwards of 300% upon lithiation generating large mechanical stresses and subsequent pulverization and solid electrolyte interphase (SEI) degradation. Effective structuring of Si below a critical dimension of 150 nm via nano spheres, nanoparticles, nanotubes, and nanowires can alleviate pulverization and subsequent active material loss associated with the large volume expansion. Some structures can address the crucial stability of the SEI layer such as double walled silicon nanotubes, highly porous silicon nanowires, and yolk-shell silicon nanoparticles. However, many of these exotic structures lack scalability such as those fabricated via chemical vapor deposition (CVD) using silane: an expensive, toxic, and pyrophoric precursor. SiO₂ can be used as a viable anode material for Li-ion batteries due to its high abundance in the earth's crust, low discharge potential, and high initial irreversible capacity and reversible capacity of 3744 mAhg-1 and 1961 mAhg-1, respectively. Some SiO₂-based architectures include anode structures, such as nanocubes, tree-like thin films, and carbon coated nanoparticles. Non-stoichiometric silicon oxides (SiOₓ, where 0<x<2) can also be used due the higher molar ratio of silicon to oxygen. A lower oxygen content allows for higher specific capacity at the expense of cyclability.

Polydimethylsiloxane (PDMS) is an optically transparent, non-toxic, and environmentally benign organo silicon widely used in pharmaceutical and consumer applications. PDMS produces SiO₂ vapor species when heated in ambient atmosphere, which makes it an ideal precursor for templated deposition of SiO₂ at the nanoscale. Beginning at 290° C., PDMS will thermally degrade into volatile cyclic oligomers via chain-folded scission of Si—O bonds by oxygen-catalyzed depolymerization. The ability for PDMS to produce SiO₂ in vapor allows for deposition of SiO₂on a variety of templates. Specifically, hollow nano structures are of interest for Li-ion batteries due to reduced Li-ion diffusion path distance via increased surface area and small wall thicknesses. Alleviation of lithiation-induced mechanical stresses can also be accomplished through engineering interior voids in the active material. Herein, a modified procedure is shown for fabricating SiOₓ NTs, as use in Li-ion battery anodes.

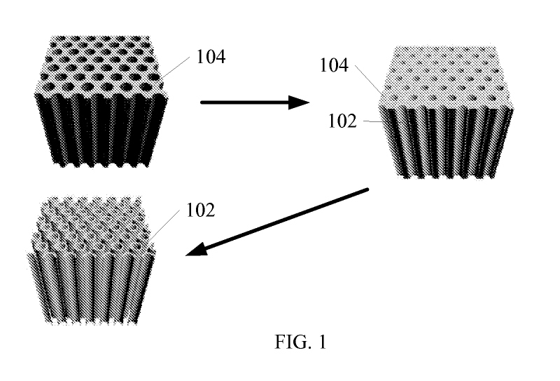

The fabrication process for SiOₓ NTs is illustrated schematically in FIG. 1. An amorphous layer of SiOₓ 102 is deposited onto commercial anodized aluminum oxide (AAO) templates 104 via vapor phase deposition through thermal degradation of PDMS in air under vacuum. The SiOₓ conformally coats all exposed surfaces of the AAO including the top and bottom of the template, creating a connected network of SiOₓ. The AAO is subsequently removed via a heated phosphoric acid bath to leave SiOₓ NTs. After rinsing several times to remove phosphoric acid, the tubes are ultrasonicated to separate the bundles of SiOₓ NTs into individual tubes. The connected SiOₓ NT network obtained after AAO removal is not mechanically sound, and thus the tubes must be sonicated apart so that they may be handled facilely.

In one example, a 20 nm coating of SiO₂ on a 13 mm diameter AAO with a thickness of 50 μm produces a volumetric density of SiO2 of 0.515 gcm⁻³ and an areal density of 2.57 mgcm⁻².

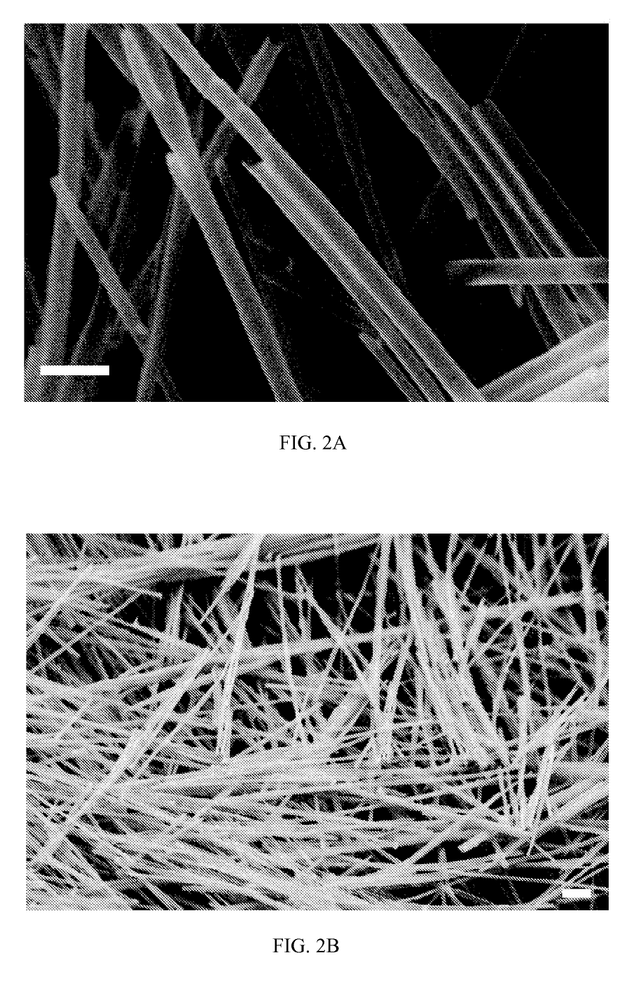

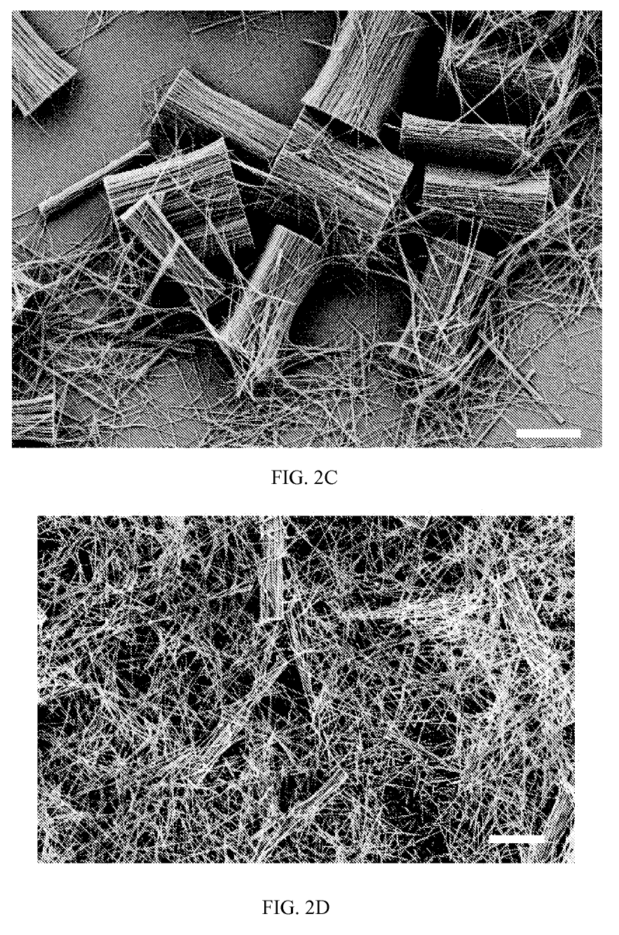

SEM images in FIG. 2A reveal the tubular morphology of the SiOₓ NTs as well as their high aspect ratio. Bundles of SiOₓ NTs occur due to deposition of SiOₓ on the tops and bottoms of the AAO templates, but brief sonication serves to easily liberate the tubes. The SEM images also reveal the excellent uniformity of the SiOₓ coating across the AAO templates and throughout their thickness. SEM imaging reveals the interconnected nature of the SiOₓ NTs after removal of the AAO template as seen in FIG. 2C. These small bundles occur after a brief period of sonication and further sonication serves to fully separate all of the tubes. The tubes have a very high aspect ratio of 250:1 at a length of 50 μm and a diameter of 200 nm. SEM reveals the branched morphology of the SiOₓ NTs, which serves to further increase the surface area of the tubes.

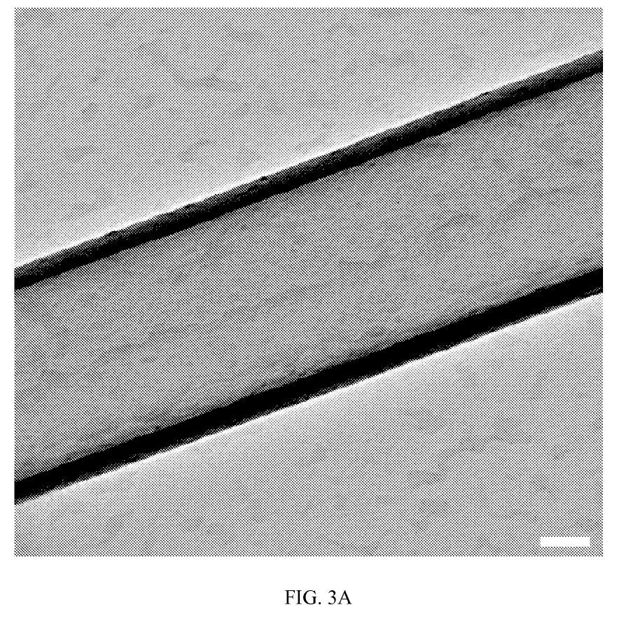

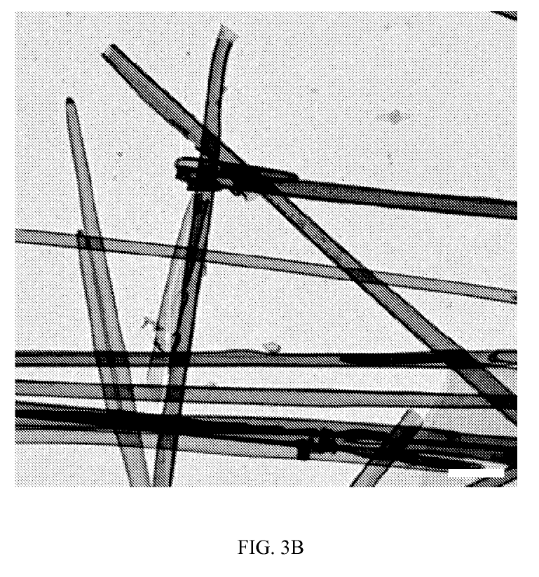

TEM images reveal the wall thickness is 20 nm and highly uniform throughout the length of the tubes as in FIG. 3A. The majority of tubes imaged exhibit a branched structure as seen in FIG. 3B, and no evidence suggests porosity exists in the walls. TEM confirms the SiO₂ NTs have an average diameter of 200 nm, which is expected given the commercial AAO template specifications. Based on the random fracture patterns generate via ultrasonication, the tubes are composed of amorphous SiOₓ.

Scanning transmission electron microscopy (STEM) and energy dispersive spectroscopy (EDS) are further performed to confirm the composition of the as-prepared nanotube samples. The STEM-EDS sample was simply prepared via transferring vacuum-dried SiO₂ NTs onto a copper TEM grid. EDS microanalysis shows the SiO₂ NTs consists of primarily Si and O. EDS element mapping micrographs of Si and O suggest a very uniform distribution of these two elements. Traceable amount of C, Al, P (wt % <1%) were observed due to carbon contaminates, unetched AAO, and unremoved H₃PO₄ etchant, respectively. An EDS quantitative analysis was performed to characterize the weight and atomic percentages of elements and to confirm the existence of SiO₂.

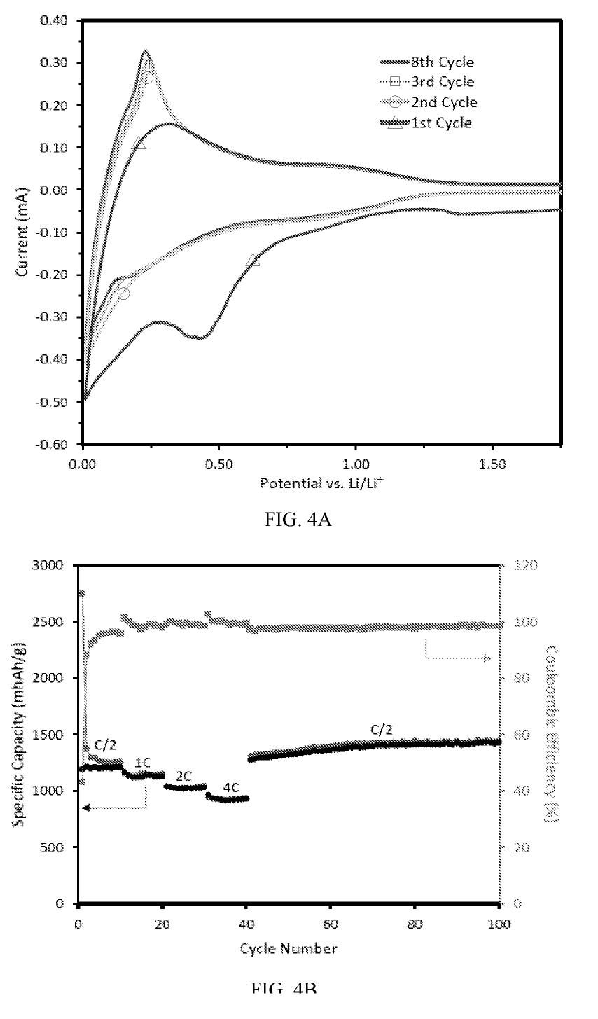

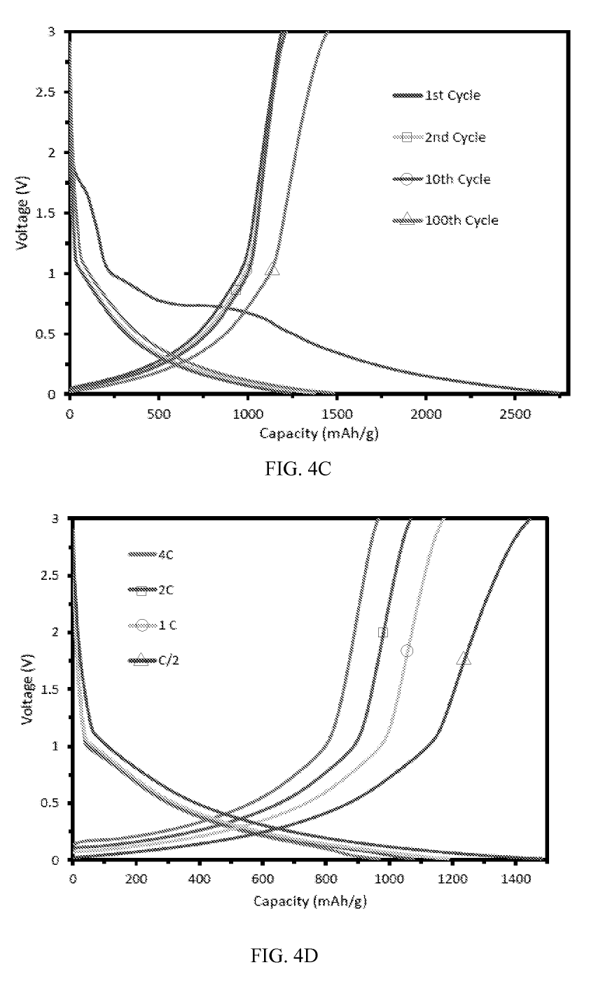

The electrochemical performance of SiO₂ NTs was characterized by fabricating 2032 coin cells with SiO₂ anodes and Li metal counter electrodes. Cyclic voltammetry (CV) was performed in the 0-3.0 V range with a scan rate of 0.1 mVs⁻¹, shown in FIG. 4A. The CV plot is shown to 1.75 V to emphasize the noteworthy reactions taking place at lower voltages. Decomposition of the electrolyte and formation of the SEI layer occurs at the broad peak of 0.43 V as in FIG. 4A. A much broader, less discernable peak occurs at 1.40 V which can be attributed to a reaction between electrolyte and electrode and the beginning of SEI formation. Both of these peaks become undiscernible in the 2^{nd} cycle suggesting SEI formation takes place mostly during the first cycle and that these initial reactions are irreversible. During the initial charge cycle a noticeable peak occurs at 0.33 V, which can be attributed to dealloying. In subsequent cycles this peak becomes very pronounced and shifts downward to 0.25 V. The sharpening and growth of this dealloying peak implies a rate enhancement in the kinetic process of delithiation of SiO₂ NTs. The kinetic enhancement may be due to the formation of an embedded nano-Si phase as it has been reported that one of the oxidation peaks of Si is 0.25 V during Li extraction from LiₓSi. By the 10^{th} cycle there is an emergence of an anodic peak located at 0.22 V while the peak at 0.01 V has decreased. It is known in the literature that the 0.01 V and 0.22 V peaks are associated with the lithiation of Si. The CV curves are in good agreement with the charge-discharge profiles in FIG. 4C and 4D.

Galvanostatic cycling of SiO₂ NTs using a C rate of 100 mAg⁻¹ was performed for 100 cycles at selected current densities. The initial sharp decrease in charge capacity over the first few cycles, seen in FIG. 4A, can be attributed to the formation of the SEI layer. The very thin walls of the SiO₂ NTs allows for lithiation of a larger percentage of active material and thus the marked high capacity relative to other published SiO₂ anodes utilizing thicker structures. As shown in FIG. 4B, the initial charge capacity is 2404 mAhg⁻¹ using a rate of C/2, and the initial discharge capacity is 1040 mAhg⁻¹ yielding a 1^{st} cycle efficiency of 43.3%; this is attributed to the SEI formation. After 10 cycles the charge capacity levels off to 1101 mAhg⁻¹ and the discharge capacity increases to 1055 mAhg⁻¹; this yields an efficiency of 95.8%. Expectedly, cycling at higher rates produces lower charge capacities as follows: 1008 mAhg⁻¹ at 1C, 914 mAhg⁻¹ at 2C, and 814 mAhg⁻at 4C. After 100 cycles the charge and discharge capacity increase to 1266 mAhg⁻¹ and 1247 mAhg⁻¹, respectively; the efficiency is 98.5%.

The large irreversible capacity in the initial charge cycle can be attributed to the formation of irreversible compounds Li₂O and Li₄SiO₄ as below and, thus, a large consumption of lithium. These electrochemically inactive and thermodynamically stable compounds are also responsible for the low efficiency in the first cycle.

SiOₓ+yLi [symbol] Si+Li_{y}Oₓ

xLi+Si [symbol] LiₓSi

yLi+SiOₓ [symbol] Li_{y}SiOₓ

After the initial decrease in capacity due to SEI formation, the capacity steadily increases until stabilizing at around 80 cycles. We believe this capacity increase is due to the increasing amount of silicon as the SiO₂ is partially reduced by Li and not fully reduced back to SiO₂. Ban et al. proposed capacity in SiO₂ anodes increases over time due to growth of the Si phase and, thus, a growth in Si volume. The formation of Li_{y}SiOₓ at Si/SiOₓ boundaries leads to the formation of three-fold coordinated Si [Si(III)] which reflects through SiO₄ tetrahedra to bond to the silicon phase. The capacity gained by inclusion of new Si atoms (˜4 Li per Si) in the Si phase outweighs the loss in capacity due to the consumption of SiO₂ in the irreversible formation of Li_{y}SiOₓ. We do not attribute this increase in capacity to increases in operating environment temperatures as several cells were tested in a staggered sequence with the same phenomenon observed in all cells. CV also supports this claim via the significant heightening and narrowing of the dealloying peak, suggesting more Li⁺ is able to be dealloyed from the SiO₂ NTs in subsequent cycles. The emergence of an anodic peak at 0.22 V in the CV plot by the 10^{th} cycle is consistent with the lithiation of Si.

Synthesis of SiOₓ NTs were achieved via the following synthesis steps: Sylgard silicone elastomer was mixed in a 10:1 ratio with a curing agent and the mixture was set at 140° C. for 10 minutes to form a solid PDMS block. The PDMS block was cut via straight-blade into 50 mg blocks and placed in a graphite crucible. Whatman Anodisc Anodic Aluminum Oxide templates with the following properties were used: 13 mm in diameter, 0.2 um pore diameter, and 50 μm template thickness. Six AAO templates were placed inside the crucible next to the PDMS block and placed inside a quartz tube in a MTI GSL1600X box furnace. The system was pumped down to 300 torr with a slow ambient air flow to allow for sufficient oxygen supply for the PDMS thermal degradation reaction. The system was heated to 650° C. and held for 1 hour to allow for complete reaction of all PDMS. After cooling, templates were sonicated in IPA for 10 s to remove excess and loosely-bonded SiOₓ and dried under nitrogen stream. The SiOₓ coated AAO templates were placed in 50% wt H₃PO₄ and etched for 48 hours at 70° C. to completely dissolve the AAO template. The SiOₓ tubes were washed several times with DI water and dried at 90° C. under vacuum for 1 hour. SiOₓ NTs were then sonicated in IPA for 30 minutes to break apart the bundles of SiOₓ NTs and then dried under vacuum at 90° C. for 1 hour.

The morphology of the sample is studied via scanning electron microscopy (SEM, leo-supra, 1550) with an X-ray energy-dispersive spectroscopy (EDS). Transmission electron microscopy (TEM, Philips, CM300) with an acceleration voltage at 300 kV is used to perform the high resolution imaging. The TEM sample was prepared by dropping pre-dispersed SiO₂ NTs onto carbon film coated TEM grids.

Electrochemical performance of SiOₓ NTs was characterized vs. Li using CR2032 coin cells with an electrolyte comprising 1 M LiPF₆ in ethylene carbonate and diethyl carbonate (EC:DEC=1:1, v/v). Electrodes were prepared via mixing SiOₓ NT powder, Super P acetylene black, and polyvinyldene fluoride (PVdF) in a weight ratio of 5:3:2. The slurry was then compressed onto copper foils and allowed to dry at 90° C. for 12 hours. Cells were assembled in an Argon-filled glovebox. All cells were tested vs. Li from 0.01 to 3.0 V using an Arbin BT2000 at a current density of 100 mAhg-1.

FIG. 5 shows an example of a battery 500 according to an embodiment of the invention. The battery 500 is shown including an anode 510 and a cathode 512. An electrolyte 514 is shown between the anode 510 and the cathode 512. In one example, the battery 500 is a lithium-ion battery. In one example, the anode 510 is formed from one or more silicon oxide nanotubes as described in examples above. In one example, although the invention is not so limited, the battery 500 is formed to comply with a 2032 coin type form factor.

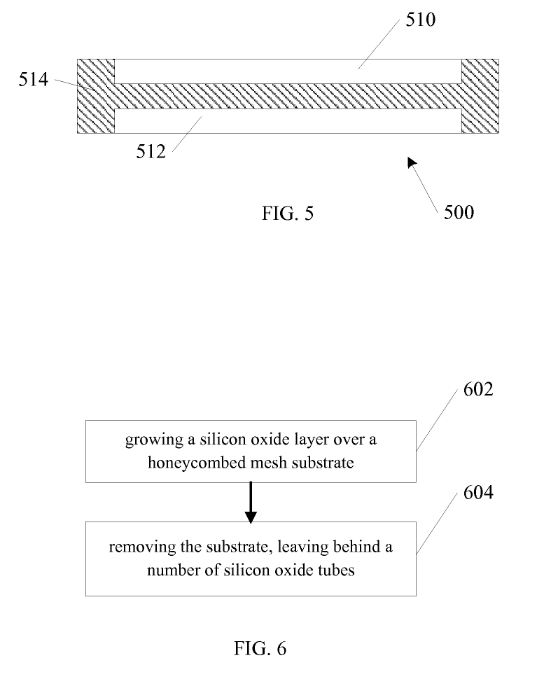

FIG. 6 shows an example method of forming a material according to an embodiment of the invention. In operation 602, a silicon oxide layer is grown over a honeycombed mesh substrate. In operation 604, the substrate is removed, leaving behind a number of silicon oxide tubes. In one example, the mesh substrate includes an anodized aluminum oxide structure, although the invention is not so limited. In one example, the material formed is further incorporated into an electrode of a battery. In one example, the electrode is an anode. In one example, the battery is a lithium ion battery.

To better illustrate the method and device disclosed herein, a non-limiting list of embodiments is provided here:

Example 1 includes a battery, including a pair of electrodes, including an anode and a cathode, a number of silicon oxide nanotubes coupled to at least one of the pair of electrodes, and an electrolyte between the anode and the cathode.

Example 2 includes the battery of example 1, wherein the number of silicon oxide nanotubes are coupled to the anode.

Example 3 includes the battery of any one of examples 1-2, wherein one of the pair of electrodes includes a lithium compound to form a lithium ion battery.

Example 4 includes the battery of any one of examples 1-3, wherein the number of silicon oxide nanotubes include silicon oxide nanotubes having an aspect ratio of approximately 250:1.

Example 5 includes the battery of any one of examples 1-4, wherein the number of silicon oxide nanotubes include silicon oxide nanotubes having a length of approximately 50 μm.

Example 6 includes the battery of any one of examples 1-5, wherein the number of silicon oxide nanotubes include silicon oxide nanotubes having a diameter of approximately 200 nanometers.

Example 7 includes the battery of any one of examples 1-6, wherein the number of silicon oxide nanotubes include silicon oxide nanotubes having a wall thickness of approximately 20 nanometers.

Example 8 includes the battery of any one of examples 1-7, wherein the number of silicon oxide nanotubes are substantially amorphous.

Example 9 includes a method, that includes growing a silicon oxide layer over a honeycombed mesh substrate, and removing the substrate, leaving behind a number of silicon oxide tubes.

Example 10 includes the method of example 9, wherein growing silicon oxide layer includes evaporating a silicone elastomer in the presence of the honeycombed mesh structure.

Example 11 includes the method of any one of examples 8-9, wherein growing the silicon oxide layer over the honeycombed mesh substrate includes growing a silicon oxide layer over an anodized aluminum oxide structure.

Example 12 includes the method of any one of examples 8-11, wherein removing the substrate includes etching using an acid bath.

Example 13 includes the method of any one of examples 8-12, wherein removing the substrate includes etching using a heated phosphoric acid bath.

Example 14 includes the method of any one of examples 8-13, further including forming the number of silicon oxide tubes into a first electrode.

Example 15 includes the method of example 14, further including coupling a second electrode adjacent to the first electrode, separated from the first electrode by an electrolyte.

Example 16 includes the method of example 15, wherein coupling a second electrode adjacent to the first electrode, separated from the first electrode by an electrolyte includes coupling a second electrode adjacent to the first electrode, separated from the first electrode by a lithium containing electrolyte.

While a number of advantages of embodiments described herein are listed above, the list is not exhaustive. Other advantages of embodiments described above will be apparent to one of ordinary skill in the art, having read the present disclosure. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A battery, comprising:
a pair of electrodes, including an anode and a cathode;
a number of silicon oxide nanotubes coupled to at least one of the pair of electrodes; and
an electrolyte between the anode and the cathode.

2. The battery of claim 1, wherein the number of silicon oxide nanotubes are coupled to the anode.

3. The battery of claim 1, wherein one of the pair of electrodes includes a lithium compound to form a lithium ion battery.

4. The battery of claim 1, wherein the number of silicon oxide nanotubes include silicon oxide nanotubes having an aspect ratio of approximately 250:1.

5. The battery of claim 1, wherein the number of silicon oxide nanotubes include silicon oxide nanotubes having a length of approximately 50 μm.

6. The battery of claim 1, wherein the number of silicon oxide nanotubes include silicon oxide nanotubes having a diameter of approximately 200 nanometers.

7. The battery of claim 1, wherein the number of silicon oxide nanotubes include silicon oxide nanotubes having a wall thickness of approximately 20 nanometers.

8. The battery of claim 1, wherein the number of silicon oxide nanotubes are substantially amorphous.

9. A method, comprising:
growing a silicon oxide layer over a honeycombed mesh substrate; and
removing the substrate, leaving behind a number of silicon oxide tubes.

10. The method of claim 9, wherein growing silicon oxide layer includes evaporating a silicone elastomer in the presence of the honeycombed mesh structure.

11. The method of claim 9, wherein growing the silicon oxide layer over the honeycombed mesh substrate includes growing a silicon oxide layer over an anodized aluminum oxide structure.

12. The method of claim 9, wherein removing the substrate includes etching using an acid bath.

13. The method of claim 9, wherein removing the substrate includes etching using a heated phosphoric acid bath.

14. The method of claim 9, further including forming the number of silicon oxide tubes into a first electrode.

15. The method of claim 14, further including coupling a second electrode adjacent to the first electrode, separated from the first electrode by an electrolyte.

16. The method of claim 15, wherein coupling a second electrode adjacent to the first electrode, separated from the first electrode by an electrolyte includes coupling a second electrode adjacent to the first electrode, separated from the first electrode by a lithium containing electrolyte.
